(19) United States
(12) Patent Application Publication
(10) Pub. No.: US 2003/0235146 A1
(43) Pub. Date: Dec. 25, 2003

(54) Bezout precoder for transmitter in MIMO communications network

(76) Inventors: Yunnan Wu, Princeton, NJ (US); Sun Yuan Kung, Princeton, NJ (US); Jinyun Zhang, New Providence, NJ (US)

Correspondence Address: Patent Department, Mitsubishi Electric Research Laboratories, Inc., 201 Broadway, Cambridge, MA, 02139, US

(21) Appl. No.: 10/176,796

(22) Filed: Jun. 21, 2002

(51) Int. Cl. H04J 11/00

(52) U.S. Cl. 370/203

(57) ABSTRACT

A method transmits data streams in a multiple-input/multiple-output (MIMO) wireless communication systems, where the number of receiving antennas q is less than a number of the transmitting antennas p. The data streams are precoded with a set of finite impulse response filters according to a transfer function of the MIMO channels. The precoded data streams are transmitted over multiple-input/multiple-output channels to a receiver, where the transmitted precoded data stream are detected and decoded to perfectly recover the plurality of data streams without the use of an equalizer.

### FIELD OF INVENTION

The present invention relates generally to the field of wireless communications, and more particularly to transmitters in multi-input/multi-output (MIMO) communication systems.

### BACKGROUND OF THE INVENTION

Rapid progress in wireless communications, such as cellular networks, has led to an increasing demand for adaptive and efficient signal processing. Transmitter and receiver diversities in multi-input/multi-output (MIMO) channels play a key role in wireless communications. In practical applications, multi-path propagation and limited bandwidth can severely degrade receiver performance.

Inter-symbol interference (ISI) is a critical problem in MIMO channels used by wireless communication systems, such as terrestrial television broadcasting and cellular networks. In addition to ISI, inter-channel interference (ICI), is also a problem in MIMO channels. Therefore, ISI/ICI reduction is a critical component for any MIMO communication systems.

In cellular networks, up-link channels run from mobile transmitters to base station receivers, and down-link channels run from the base station transmitters to mobile receivers. The base station usually has substantial processing power, and is typically equipped with multiple transmitting and receiving antennas. In contrast, the mobile transceiver has limited processing power and only a single antenna.

In the prior art, Bezout equalizers have been used in receivers to limit ISI and ICI, see Kung et al., “An associative memory approach to blind signal recovery for SIMO/MIMO systems,” Proceedings of IEEE Workshop on Neural Networks for Signal Processing, September 2001. With the Bezout equalizer, the MIMO dispersive channel is converted into several single-input/single-output non-dispersive channels. However, the Bezout equalizer requires that the number of outputs, which is equal to the number of receiver antennas, is greater than the number of inputs or transmitter antennas. Such a requirement can be satisfied easily by the base station but not the mobile transceiver. Bezout equalizers greatly increase the complexity of the receivers.

Therefore, there still is a need for reducing ISI/ICI in receivers of a MIMO system where the number of the receiver antennas at a mobile receiver is limited, and where joint processing is not practical due to the physical separation of the receiving antennas of different transceivers.

### SUMMARY OF THE INVENTION

The present invention provides a precoder for a transmitter, such as a base station in a cellular network, to eliminate inter-symbol and inter-channel interference (ISI/ICI) in a receiver, e.g., a cellular telephone. The precoder includes a set of linear finite impulse response (FIR) filters. These filters are designed and optimized to completely eliminate the ISI/ICI on a down-link channel from a transmitter to a receiver. Therefore, the complexity of the mobile receiver can be reduced while still eliminating ISI/ICI.

The present invention applies to single user MIMO system, where the output signals correspond to different antennas of a single user, and to distributed multi-user systems, where the output signals correspond to different antennas of different users. By feeding back channel information in a frequency division duplex (FDD) system, or by estimating a reverse channel in a time division duplex (TDD) system, the channel characteristics can be determined by the transmitter at the base station. The transmitter then uses the channel characteristics to precode the out-going signals. The fact that channels in a time-division system are reciprocal is described by Esmailzadeh et al. “Time-division duplex CDMA communications,” IEEE Personal Communications, Volume: 4 Issue: 2, pp. 51-56, April 1997.

The invention provides a precoder in a transmitter to eliminate ISI and ICI in a receiver. The receiver, in contrast with the prior art, does not include a Bezout equalizer. Due to the optimum precoder design, the received signal is free of ISI and ICI. The receiver is therefore very simple, only including standard components for timing recovery, demodulation, and decoding, and some other basic functionality. An equalizer is no longer required at the receiver. Note that the Bezout equalizer is a left delay-permissive inverse of the channel, while the precoder is a right delay-permissive inverse of a channel transfer function.

More particularly, the invention provides a method which transmits data streams in a multiple-input/multiple-output (MIMO) wireless communication system, where the number of receiving antennas q is less than a number of the transmitting antennas p.

The data streams are precoded with a set of finite impulse response filters according to a transfer function of the MIMO channels. The precoded data streams are transmitted over multiple-input/multiple-output channels to a receiver, where the transmitted precoded data stream are detected and decoded to recover the plurality of data streams without the use of an equalizer.

### BRIEF DESCRIPTION OF THE DRAWINGS

FIG. 1 is a block diagram of a MIMO system with a Bezout precoder according to the invention; and

FIG. 2 is a block diagram of a method for determining filter coefficients for the precoder according to the invention.

### DETAILED DESCRIPTION OF THE PREFERRED EMBODIMENT

MIMO System Model with Precoder

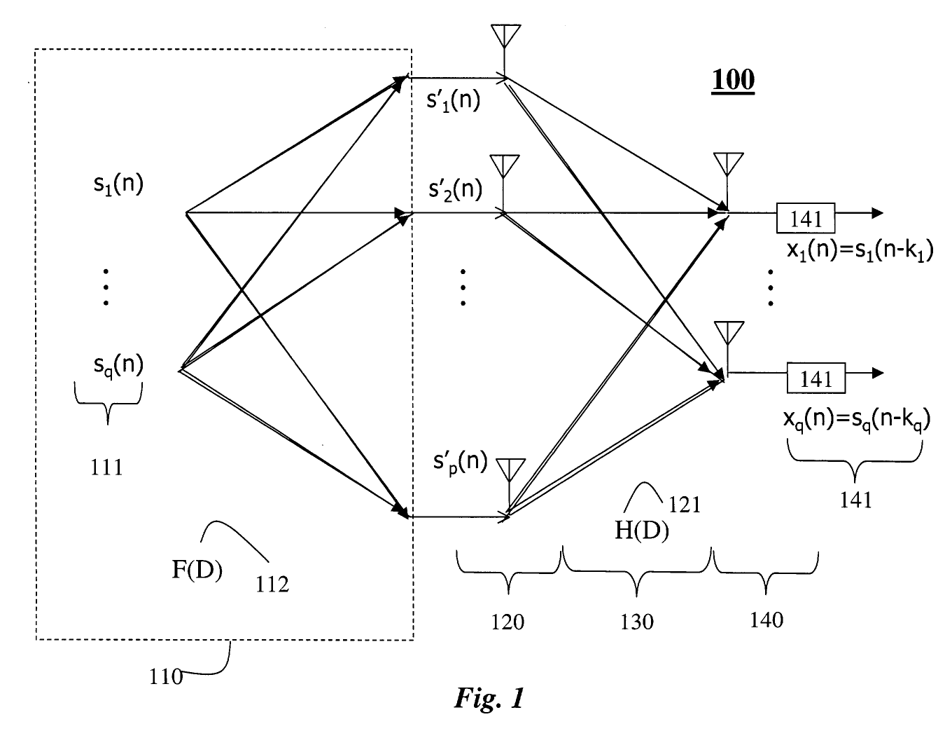

FIG. 1 shows a multi-input/multi-output (MIMO) system 100 according to the invention. The MIMO system 100 includes a precoder 110, a transmitter with p transmitting antennas 120, a MIMO channel 130, and a receiver with q receiving antennas 140, where q<p. The precoder 110 includes a filter bank F(D) 112 described in greater detail below. In one implementation of the invention, the receiver is a cellular telephone with a single antenna.

The receiver includes standard components 150 for timing recovery, demodulation, and decoding, and some other basic receiver functionality. However, the receiver does not include a Bezout equalizer for ISI/ICI reduction, as in the prior art. Instead, ISI\ICI reduction is accomplished by the precoder 110 in the transmitter.

The precoder 110 takes q data streams s_{q}(n) 111 as input and produces p data streams ^{s′}ₚ(n) 115 as output for the p transmitting antennas 120 using the filter bank F(D) 112. The transmitter sends the signals over the MIMO channel 130. The receiving antennas 140 detect p transmitted signals, and perfectly recover q data streams x_{q}(n) 141, without the use of an equalizer.

If s′hd j(k) 115 denotes the sequence of symbols produces by the precoder 110 for the p transmitting antennas 120, for j=1, . . . , p, and hᵢⱼ(k) is the channel response from transmitter j to receiver i=1, . . . , q, then,

$${x}_{i} ( k ) = {\sum }_{j = 1}^{p} {\sum }_{l = 0}^{d} {h}_{ij} ( l ) {s}_{j}^{′} ( k - l ) ,$$

where d denotes a maximal ISI length.

The above convolution can be expressed equivalently in a z-transform domain as:

H(D)s′(D)=x(D)

where,

s′(D)=[s′₁(D) s′₂(D) . . . s′ₚ(D)]^{T}, x(D)=[x₁(D) x₂(D) . . . x_{q}(D)]^{T} and H(D)={hᵢⱼ(D)} are the z-transform vectors (matrix) of the corresponding sequences or impulse responses of the channels 130.

Departing from the traditional z-transform notation, here the delay operator is denoted by D instead of by z⁻¹. The p-input-q-output MIMO channel 130 can then be represented by a q×p matrix H(D) 121, which is referred to as the transfer function of the MIMO system 100.

The precoder's filters F(D) 112 takes the data streams sᵢ(k), i=1, . . . , q 111, as inputs and generates the p transmitted signals s′ⱼ(k), j=1, . . . , p as outputs 115. With the preceding filters F(D) 112, the received signal x(D) can be expressed as:

H(D)F(D)s(D)=x(D)

where s(D) is the z-transform vector of the data streams sᵢ(k), for i=1, . . . , q.

Definition of the Bezout Precoder

If q<p, then the FIR filter bank F(D) 112 is a Bezout precoder for the channel transfer function H(D) 121, if and only if

$$H ( D ) F ( D ) = [ \begin{matrix}{D}^{{k}_{1}} & & 0 \\ & ⋰ & \\ 0 & & {D}^{{k}_{q}}\end{matrix} ]$$

This is called Bezout precoder because this equation satisfies the generalized Bezout identity. The Bezout precoder exploits the polynomial algebra property of the channel to eliminate ISI and ICI. From the polynomial algebra associated with the generalized Bezout identity, signal recoverability condition, and the relationship between the transmitted and received data can be determined.

With the Bezout precoder 110, the symbols received by the receiver are ISI and ICI-free. In the absence of noise, the received symbols are a delayed version of the transmitted symbols, hence the input data streams are perfectly recoverable.

Existence Conditions of Bezout Precoder

The MIMO system 100 with the matrix transfer function H(D) 121 is perfectly recoverable by the Bezout precoder 110 if and only if H(D) is left coprime, except for a left common factor with determinant D^{k}.

Optimal Bezout Precoder

With the Bezout precoder 110, the receiver can perfectly recover the input streams under an idealistic assumption that the system 100 is noise free. However, noise is pervasive in all practical applications. Therefore, it is important to understand the performance of Bezout precoder's filter bank F(D) 112 for noisy channels and select the one with the best noise resilience.

For the Bezout precoder 110 H(D)F(D)=Diag[D^{k}^{ᵢ}], one column of F(D) 112 is denoted by f(D)=f₀+Df₁+ . . . +D^{ρ-1}f_{ρ-1}, and its expanded column vector is denoted by

\vec{f}=[f₀^{T}f₁^{T} . . . f_{ρ-1}^{T}],

where ρ denotes the tap-length of the precoder's filter.

In order to have an ISI/ICI-free communication, the following requirement are met

H(D)fⁱ(D)=[0 . . . D^{k}^{ᵢ} . . . 0]^{T}, i=1, . . . , q

The received SNR (signal-to-noise ratio) for the i-th stream is

$$\frac{{( {σ}_{s}^{i} )}^{2}}{{σ}_{n}^{2}} ,$$

where (σₛⁱ)² is the signal power of the i-th stream, and σₙ² is the noise power for the i-th stream. The total transmission power at the transmitting antennas due to the i-th stream is (σₛⁱ)²∥\vec{f}ⁱ∥²,because each FIR filter fⁱ(D) amplifies the signal power by a factor of ∥\vec{f}ⁱ∥², when the input sequences are independent from sample to sample. Therefore, the optimal Bezout precoder filter for the source inputs 111 is equivalent to multiple individually optimized precoder filters, one for each input.

Consequently, in the optimal individual Bezout precoder, the ith filter fⁱ(D) has a minimal two-norm (largest singular value in a matrix) ∥fⁱ(D)∥²≡∥\vec{f}ⁱ∥², such that

H(D)fⁱ(D)=[0 . . . D^{k}^{ᵢ} . . . 0]^{T}, i=1, . . . q.

It should be noted that the system delay kᵢ is a design parameter, thus, the two-norm of fⁱ(D) can be reduced.

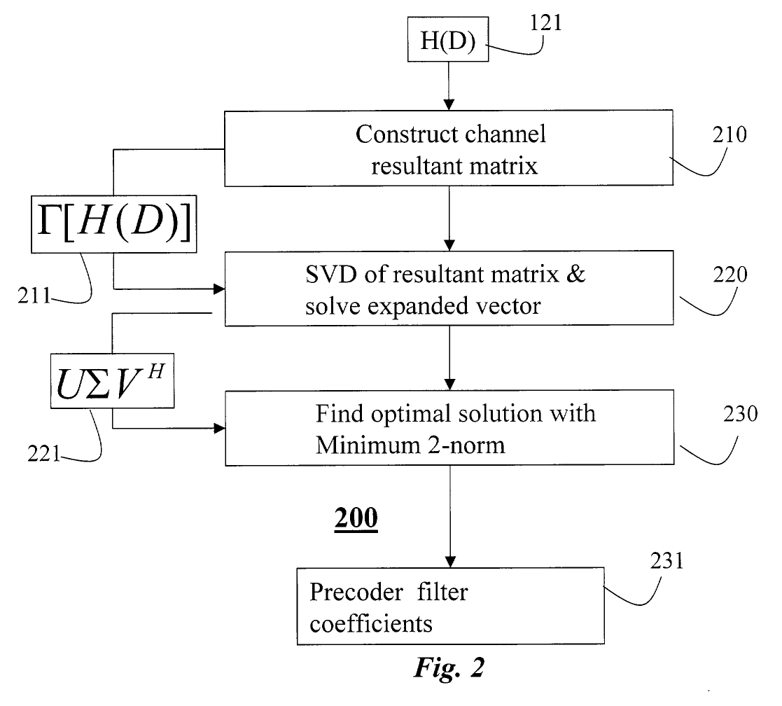

FIG. 2 shows the steps of a method 200 for designing the optimal fⁱ(D) using a resultant matrix.

Step 210 constructs a MIMO channel resultant matrix 211 from the transfer function H(D) 121. If the transfer function H(D) 121 of the channel 130 is expressed in terms of coefficient matrices as H(D)=H₀+H₁D+ . . . +H_{d-1}D^{d-1}+H_{d}D^{d}, then the resultant matrix 211 is defined as:

$$Γ [ H ( D ) ] = [ \begin{matrix}{H}_{0} & & & \\ ⋮ & {H}_{0} & & \\ {H}_{d} & ⋮ & ⋰ & \\ & {H}_{d} & ⋮ & {H}_{0} \\ & & ⋰ & ⋮ \\ & & & {H}_{d}\end{matrix} ] ,$$

where the size of the resultant matrix 211 is (d+ρ)q×ρp, d is the maximal ISI length of the channel, and ρ is defined as the tap-length of the FIR filter of the precoder 110.

Step 220 performs a singular value decomposition (SVD) on the channel resultant matrix 121 and solves for the expanded vector \vec{f}ⁱ. Thus, the equation H(D)fⁱ(D)=[0 D^{k}^{ᵢ}. . . 0]^{T}, i=1, . . . , q can be expressed in matrix notation as:

Γ[H(D)]\vec{f}ⁱ=eₘ, m=1, . . . , (d+ρ)q.

where eₘ is a column vector with all zeros, except an entry of one at

m=i+qkᵢ, kᵢ=0, . . . ,d+ρ−1.

A singular value decomposition (SVD) is taken of Γ[H(D)] 211, with Σ being a square positive-definite diagonal matrix Σ=diag(σ₁, . . . σᵣ), where r is the rank of Γ[H(D)], U and V are unitary matrices trimmed to the proper size conformant with Σ:

Γ[H(D)]=UΣV^{H} 221. For a given index i, a Bezout precoder filter \vec{f} exists if and only if a solution b for Ub=eₘ exists. In other words, \vec{f}ⁱ is obtained by solving the equation: UΣV^{H}\vec{f}ⁱ=eₘ.

Step 230 selects the optimum of all feasible solutions to determine the filter coefficients 231 of the Bezout precoder 110. This Bezout precoder is

\vec{f}ⁱ=VΣ⁻¹U^{H}eₘwith the 2-norm,

∥\vec{f}ⁱ∥²=(UΣ⁻²U^{H})ₘₘ,

where the two-norm, by definition, is the largest singular value in a matrix.

The optimal integer m* corresponding to the optimal delay kᵢ, with minimal 2-norm, is:

$${m}^{*} = arg {min}_{m} \{ {( U {\sum }^{- 2} {U}^{H} )}_{m m} \vert m = i ( mod q ) , {e}_{m} ∈ Column Span \{ U \} \} .$$

In other words, of the possible solution, the one with the smallest two-norm is the optimal solution.

Effect of Bezout Precoding

The main advantage of Bezout precoder 110 lies in its ability to completely eliminate ISI/ICI for wireless MIMO channels with more inputs than outputs. The low complexity precoder can be implemented in a transmitter, such as a base station of a cellular network, to simplify the design of wireless receivers. In fact, there is no need for an equalizer in the receiver.

The Bezout precoder according to the invention provides quality-of-service (QoS) for streaming date through power control. This is useful for multi-media communications with video and audio streams at different levels of priority. With the Bezout precoder, scaling the transmitting powers scales the output signal-to-noise ratios (SNRs) by the same factor.

In other words, a diagonal power control matrix Λ can be used at the transmitter to change the system

H(D)F(D)=Diag[D^{k}^{ᵢ}]

to

H(D)F(D)Λ=Diag[D^{k}^{ᵢ}]Λ

so that the output SNR or bit error rate (BER) requirements are met for selected data streams.

Bezout preceding according to the invention can deliver the same optimal BER, at half the power, as techniques that use a space time block coder (STBC), see Alamouti, “A simple transmit diversity technique for wireless communications,” IEEE Journal on Selected Areas in Communications, Vol. 16, No. 8, pp. 1451-1458, October 1998.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for transmitting a plurality of data streams in a multiple-input/multiple-output wireless communication systems, where a number of receiving antennas q is less than a number of the transmitting antennas p, comprising:
preceding the data streams with a set of finite impulse response filters; and
transmitting the precoded data streams over a multiple-input/multiple-output channel to a receiver where the transmitted precoded data stream are detected and decoded to recover the plurality of data streams.

2. The method of claim 1 wherein the finite impulse response filters are linear.

3. The method of claim wherein there are q×p finite impulse response filters.

4. The method of claim 1 where q<p.

5. The method of claim 1 further comprising:
acquiring a transfer function of the multiple-input-multiple-output channel;
constructing a resultant matrix from the transfer function
applying a singular value decomposition to the resultant matrix to design the set of finite impulse response filters.

6. The method of claim 5 the transfer function H(D)H(D) is expressed in terms of coefficient matrices as
H(D)=H₀+H₁D+ . . . +H_{d-1}D^{d-1}+H_{d}D^{d}, and
H(D)=H₀+H₁D+ . . . +H_{d-1}D^{d-1}+H_{d}D^{d},
wherein the resultant matrix is defined as:
$$Γ [ H ( D ) ] = [ \begin{matrix}{H}_{0} & & & \\ ⋮ & {H}_{0} & & \\ {H}_{d} & ⋮ & ⋰ & \\ & {H}_{d} & ⋮ & {H}_{0} \\ & & ⋰ & ⋮ \\ & & & {H}_{d}\end{matrix} ] ,$$
where a size of the resultant matrix is (d+ρ)q×ρp, d is a maximal ISI length of the multiple-input/multiple-output channel, and ρ is defined as tap-lengths of the finite impulse response filters.

7. The method of claim 5 further comprising:
optimizing the set of finite impulse response filters by finding a particular singular value decomposition with a minimum 2-norm.

8. The method of claim 5 further comprising:
feeding back channel information in a frequency division duplex system to acquire the transfer function.

9. The method of claim 1 further comprising:
estimating a reverse channel in a time division duplex system duplex system to acquire the transfer function.

10. The method of claim 1 wherein each finite impulse response filter is a right delay-permissive inverse of an impulse response of the multiple-input/multiple-output channel.

11. The method of claim 1 wherein the precoding eliminates inter-symbol and inter-channel interference, and the receiver only includes basic components for timing recovery, demodulation, and decoding.

12. The method of claim 1 further comprising:
applying a diagonal power control matrix at each transmitter to meet a predetermined signal-to-noise ratio for selected ones of the data streams..

13. The method of claim 1 further comprising:
applying a diagonal power control matrix at each transmitter to meet a predetermined bit error rate for selected ones of the data streams.

14. The method of claim 1 wherein the q receivers are associated with a single user.

15. The method of claim 1 wherein each of the q receivers is associated with a different user.

16. The method of claim 1 wherein the receiver is a cellular telephone with a single antenna.

17. An apparatus for transmitting a plurality of data streams in a multiple-input/multiple-output wireless communication systems, where a number of receiving antennas q is less than a number of the transmitting antennas p, comprising:
a precoder to precode the data streams with a set of finite impulse response filters; and
a transmitter configured to send the precoded data streams over a multiple-input/multiple-output channel to a receiver where the plurality of data streams are detected, demodulated, and decoded to perfectly recover the plurality of data streams.
